(19) United States
(12) Patent Application Publication
(10) Pub. No.: US 2026/0341025 A1
(43) Pub. Date: Oct. 29, 2026

(54) Dynamically Allocated Edge Device System

(71) Applicant: Bank of America Corporation, Charlotte, NC (US)

(72) Inventors: Suryanarayan Chakravarthi, Chennai (IN); Rathna Prabha Kandepu, Hyderabad (IN); Krishan Gopal, Gandhinagar (IN); Shailendra Ggujar, Hyderabad (IN)

(73) Assignee: Bank of America Corporation, Charlotte, NC (US)

(21) Appl. No.: 19/187,483

(22) Filed: Apr. 23, 2025

(51) Int. Cl. G06V 20/52; H04L 67/10; H04L 67/52

(52) U.S. Cl. CPC G06V 20/52; H04L 67/10; H04L 67/52

(57) ABSTRACT

Various aspects of the disclosure relate to a dynamically allocated edge device system utilizing local video capture edge devices, local voice capture edge devices, and/or an evidence package serializer. The edge devices capture at least a portion of a transaction, such as a video snippet and/or a voice snippet. An evidence package serializer serializes and bundles transaction evidence into the referral management system. The completion evidence data is then validated automatically against transactions, where notifications and/or alerts are communicated to upstream and downstream systems for scrutiny and/or further analysis. Databases systems and/or devices may be assigned for these processes and may be based on triggers initiated by one or both of a teller associated device or system and a transaction processing systems.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization, such as processing remote electronic transactions via a plurality of devices and/or electronic transaction channels.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

Aspects of the disclosure relate to computer hardware and software. In particular, one or more aspects of the disclosure generally relate to computer hardware and software for remote processing of electronic data transfers, such as electronic transactions utilizing dynamically allocated edge devices.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes dynamically allocating edge devices, such as via spatial requests for remote transaction processing and/or remotely completed transactions between regions.

The illustrative dynamically allocated edge device system provides a single processing pipeline for completing data exchanges. For example, the edge device system may allow for assigning an enterprise network's resources, such as digital and/or non-digital networks of a financial institution, to facilitate processing of incoming on-premise and/or remote transactions and remote teller service (RTRTS) requests and spatial requests. In an illustrative example, the dynamically allocated edge device system may receive and/or process one or more RTRTS requests via one or more of the following. An edge device capture router (EDCR) component may be designated to pull available edge devices (e.g., enterprise assigned computing devices and mobile devices along with client-side mobile devices into a local processing network. For example, a local capture device (e.g., an in-vehicle capture device, a drive-through transaction capture device) may leverage audio and/or video (A/V) signals from an A/V capable device within a local client environment, such as for traveling requests. For in-vehicle capture and/or drive-through capture (e.g., a drive-through teller), the RTRTS may leverage A/V capable computing devices within a client environment (e.g., computing devices associated with a user vehicle and/or a user device associated with the user vehicle) including any special computing device requests. Processing capability for live (e.g., real-time) requests and/or static special processing requests may be available within one or more devices and/or the EDCR.

The dynamically allocated edge device system may further include local video capture edge devices, local voice capture edge devices, and/or an evidence package serializer. The local video capture edge device captures at least a portion of a transaction, such as a video snippet integrated (ViSI) teller transaction completion. The local voice capture edge device captures at least a portion of the transaction, such as a voice snippet integrated (VoSI) teller transactions completion. The evidence package serializer (Evi-P-S) is a program, or other programmed module, that serializes and bundles transaction evidence into the referral management system (TRMS). The completion evidence data is then validated automatically against transactions, where notifications and/or alerts are communicated to upstream and downstream systems for scrutiny and/or further analysis. Databases systems and/or devices may be assigned for these processes and may be based on triggers initiated by one or both of a teller associated device or system and a transaction processing systems. In some cases, database systems may not be assigned solely through any external systems.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for dynamically allocating edge devices for use in data exchange transactions, in accordance with one or more aspects described herein;

FIG. 1B shows an illustrative computing platform enabled for dynamically allocating edge devices for use in data exchange transactions, in accordance with one or more aspects described herein; and

FIG. 2 shows an illustrative system and process for dynamically allocating edge devices with illustrative data exchange transactions, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously. “Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

When placing an emphasis on remote transaction processing and/or remote teller service delivery through present enterprise networks and/or computing devices, a need has been recognized for a system that can handle and deal with both on-premise transaction requests and remote, cross-region and cross border requests to deliver teller services through same data and device channels. For example, present systems of an enterprise many electronic transactions cannot be completed in real-time or near real-time. For example, an enterprise network of a financial institution may process upwards of thirty-thousand transaction (e.g., banking) requests per day. Often a large percentage (e.g., approximately 17%, or five thousand of thirty thousand total requests) may require two to three days to complete. Additionally, a percentage of these delayed request often require four or more days due to one or more technical problems and/or challenges, such as database failures, communication failures, system outages, and/or the like.

As such, the illustrative dynamically allocated edge device system may include previously unavailable features to facilitate more efficient processing of electronic data transfers (e.g., electronic transactions) and/or service processing (e.g., a banking service), such as a requirement that a system and a mechanism to similarly process electronic transactions and electronic services delivery for both on premise and remote services. Further, the dynamically allocated edge device system may pull the data transfer requests through available devices into the enterprise architecture. The dynamically allocated edge device system may assign teller and teller services even for remote incoming requests through various digital channels, a system for similarly processing remote traveling requests such as to allocate remote services. This assignment may include a previously missing ability to process incoming spatial requests, such as Alternate reality/virtual reality (AR/VR) devices, and may further include an ability to accommodate and/or incorporate special spatial computing devices and/or wearable devices (e.g., head gear, smart glasses, and the like) at an individual level. The dynamically allocated edge device system may further capture all data transactions at related processing stages and may capture all service request delivery statuses via a variety of available edge devices, such as audio and/or video capable computing devices in an extended enterprise ecosystem. The dynamically allocated edge device system may further include a validation and/or notification system and/or model that can package transaction related captured video and/or audio snippet outcomes and can temporally serialize each snippet for model validation and/or evidence scrutiny. The dynamically allocated edge device system may further be extended to provide support and/or technical processing capability to continue operation of data exchange transactions (e.g., an electronic transactions) and service delivery (e.g., deliver enterprise-related digital services) during failure of one or more back-end or other interrelated computing systems to facilitate one or more disaster recovery scenarios and operations continuity needs.

The dynamically allocated edge device system, such as one specifically programmed for use in an enterprise network of a financial institution, may process both on-premise data exchange transactions and/or remote data exchange transactions or remote teller service (RTRTS) data exchange requests similarly and through a same processing pipeline. For example, a designated system present at an enterprise network may include an edge device capture router (EDCR) component, to pull in required and available edge devices for requests related to transaction and teller services processing including reading and processing external spatial requests. The dynamically allocated edge device system may further interface with a plurality of computing devices capable of audio and/or video capture, where these A/V capture devices may communicate with components of the dynamically allocated edge device system for video snippet (ViSI) and voice snippet (VoSI) integration, where the captured snippets may be used for completion of data exchange transactions may utilize a dedicated load balancer to facilitate processing for remote traveling request distribution. The dynamically allocated edge device system may further include an Evidence Package Serializer (Evi-P-S) engine to serialize and bundle data exchange transaction information, which are then pre-validated and scrutinized for correctness for use in completion of associated data exchange transactions or service delivery with or without flagging alerts.

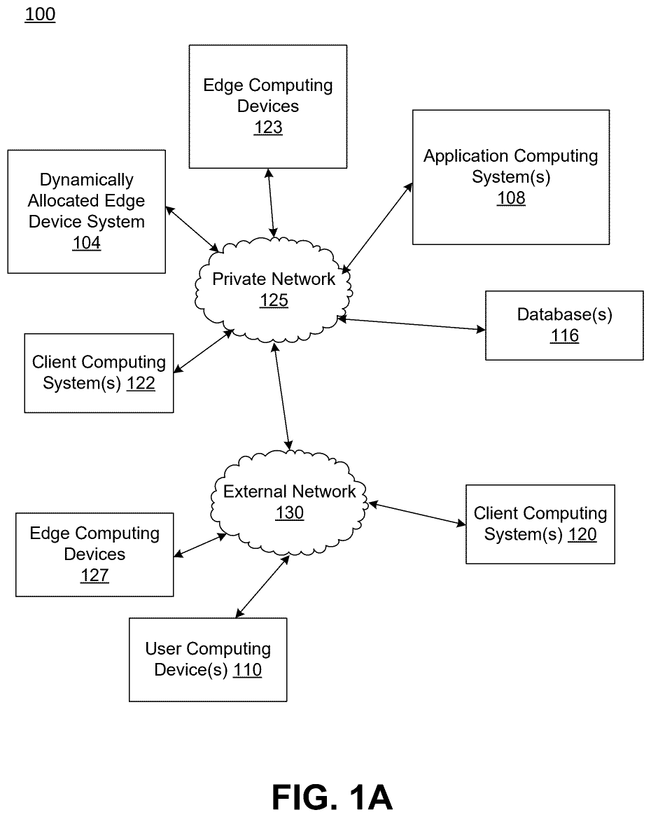

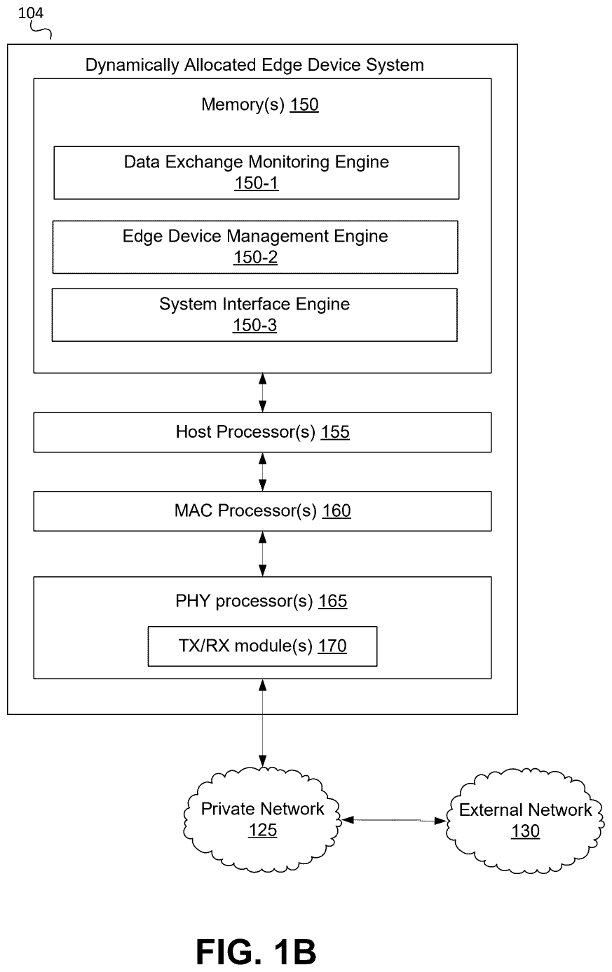

FIG. 1A shows an illustrative computing environment 100 for dynamically allocating edge devices for use in data exchange transactions, in accordance with one or more arrangements. The computing environment 100 may comprise one or more devices (e.g., computer systems, communication devices, and the like). The computing environment 100 may comprise, for example, a dynamically allocated edge device system 104, one or more application computing systems 108, a client computing system 122, one or more edge computing devices 123, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120, one or more edge computing devices 127, and one or more user devices 110 (e.g., one or more edge computing devices) connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the dynamically allocated edge device system 104 as being a stand-alone system, some, or all components of the dynamically allocated edge device system 104 may be incorporated within one or more separate computing systems such as, for example, the application computing systems 108.

The dynamically allocated edge device system 104 may comprise one or more computing devices and/or other computer components (e.g., processors, memories, communication interfaces) configured to perform one or more functions as described herein. Further details associated with the architecture of the dynamically allocated edge device system 104 are described with reference to FIG. 1B.

The application computing systems 108 and/or the client computing system 122 may comprise one or more computing devices and/or other computer components (e.g., processors, memories, communication interfaces). In addition, the application computing systems 108 and/or the client computing system 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing system 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing system 122 and/or the application computing systems 108 may comprise various servers and/or databases that store and/or otherwise maintain account information, such as financial account information including account balances, transaction history, account owner information, and/or other information. In addition, the client computing system 122 and/or the application computing systems 108 may process and/or otherwise execute transactions on specific accounts based on commands and/or other information received from other computer systems comprising the computing environment 100. In some cases, one or more of the client computing system 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing system 120 and the one or more application computing systems 108.

The user device(s) 110 and/or the edge computing devices 123 and the edge computing devices 127 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125. In some cases, the edge computing devices 123 and the edge computing devices 127 may include input circuitry and devices to capture audio and/or video within its local environment. For example, an edge computing device may include one or both of a microphone to capture an audio signal and a still or video camera to capture a video signal corresponding to actions occurring in the vicinity of the edge computing device. The edge computing devices 123 and the edge computing devices 127 may communicate the audio and/or video signals captured as real-time signals or as a pre-recorded signal from files stored in memory following capture of the audio and/or video signals. In some cases, the edge computing devices 123 and the edge computing devices 127 may communicate a portion of the real-time signals or pre-recorded or buffered signals, such as via an audio snippet and/or a video snippet.

The database(s) 116 may comprise one or more computer-readable memories storing information that may be used by the dynamically allocated edge device system 104. For example, the database(s) 116 may store information corresponding to electronic data exchanges (e.g., electronic transactions), electronic data exchange initiation information, user information associated with an electronic data exchange, an audio snippet data store, a video snippet data store, a referral management system audit result data store, and the like. In an arrangement, the database(s) 116 may be used for other purposes as described herein. In some cases, the client computing system 120 may write data or read data to the database(s) 116 via the services.

In one or more arrangements, the dynamically allocated edge device system 104, the application computing systems 108, the client computing system 122, the client computing system 120, the edge computing devices 123, the edge computing devices 127, the user devices 110, and/or the other devices/systems in the computing environment 100 may be any type of computing device capable of receiving input via a user interface, and communicating the received input to one or more other computing devices in the computing environment 100. For example, the dynamically allocated edge device system 104, the application computing systems 108, the client computing system 122, the client computing system 120, the edge computing devices 123, the edge computing devices 127, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the dynamically allocated edge device system 104, the application computing systems 108, the client computing system 122, the client computing system 120, the edge computing devices 123, the edge computing devices 127, the user devices 110, and/or the other devices/systems in the computing environment 100 may, in some instances, be and/or comprise special-purpose computing devices configured to perform specific functions.

FIG. 1B shows an illustrative dynamically allocated edge device system 104 in accordance with one or more examples described herein. The dynamically allocated edge device system 104 may be a stand-alone device and/or may at least be partial integrated with one or more of the application computing systems and may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The dynamically allocated edge device system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the dynamically allocated edge device system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the dynamically allocated edge device system 104 may be configured to execute machine readable instructions stored in memory 150. The memory 150 may comprise (i) one or more program modules/engines having instructions that when executed by the one or more processors cause the dynamically allocated edge device system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the dynamically allocated edge device system 104 and/or by different computing devices that may form and/or otherwise make up the dynamically allocated edge device system 104. For example, the memory 150 may have, store, and/or comprise a data exchange monitoring engine 150-1, an edge device management engine 150-2, a system interface engine 150-3, and/or the like. The data exchange monitoring 150-1 may have instructions that direct and/or cause the dynamically allocated edge device system 104 to perform one or more operations associated with identifying and monitoring initiation and/or completion of data exchanges, such as electronic transactions initiated from multiple sources and completed via a plurality of devices, and the like. The edge device management engine 150-2 may have instructions that may cause the dynamically allocated edge device system 104 to identify and manage communications to one or more edge computing devices 123, one or more edge computing devices 127, and/or the like. The edge device management engine 150-2 further manages system interaction with the edge computing devices 123 and edge computing devices 127 to capture relevant audio snippets, video snippets, and the like. The system interface engine 150-3 may have instructions that may cause the dynamically allocated edge device system 104 to balance operation between different system resources, reallocation of computing resources to complete each electronic transaction.

While FIG. 1A illustrates the dynamically allocated edge device system 104 and/or the application computing systems 108, as being separate elements connected in the private network 125, in one or more other arrangements, functions of one or more of the above may be integrated in a single device/network of devices. For example, elements in the dynamically allocated edge device system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

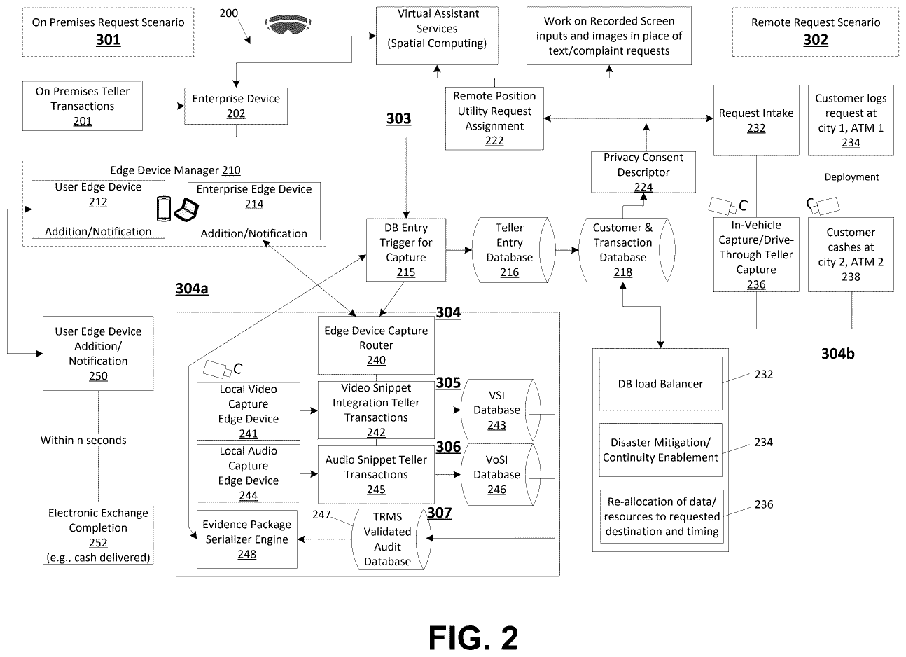

FIG. 2 shows an illustrative system and process for dynamically allocating edge devices with illustrative data exchange transactions, in accordance with one or more aspects described herein. At 301, an on-premises system interacts with enterprise associated edge devices and/or user edge devices to initiate a data exchange transaction, such as a electronic transaction. At 302, the dynamically allocated edge device system delivers remote assisted transactions over a region, such as via a virtual assist system and/or a teller assignment system, for example, where also processing external spatial requests. This portion may be only based on user requirements and/or automated teller machine capabilities, such as from drive-through teller services, remote city delivery and/or an assigned automated teller machine based on a user-defined destination.

At 303, the dynamically allocated edge device system configures a requested delivery in remote locations across regions using end devices but utilizing in-house processing and delivery. At 304, one or more edge devices pull setup and/or configuration information for localized entry processing, wherein operations for on-premises operations at 304a operate similarly via a same underlying system at 304b for remote transaction requests. Edge devices pull setup for bank side localized entry processing for both localized entry processing and remote request-initiated processing. At 305, video signals captured by local edge devices are communicated to a module for creating and/or otherwise processing the video signals into video snippets for use within the system. Similarly, at 306, audio signals captured by local edge devices are communicated to a module for creating and/or otherwise processing the audio signals into audio snippets for use within the system. At 307, an evidence package serializer module may enable user, enterprise organization and/or vehicle edge devices for use by a transaction validation system. The evidence package serializer module communicates this information to facilitate an evidence bundling and/or validation notification system for automated identification of problematic electronic transactions and/or for closing, settling, or otherwise completing the data exchange transactions.

For an on-premises request scenario at 301, a user may initiate a transaction at 201, where an assigned teller may utilize an enterprise computing device 202 to facilitate entry of the transaction request. An edge device manager 210 may identify and/or on-board one or more user edge devices 212 and/or enterprise edge devices 214 to assist with processing the transaction request. The enterprise device 202 may further interact with a virtual assistant, which may further be associated with an enterprise edge device, such as AR glasses or other edge device. At 303, the enterprise device 202 may trigger a database entry trigger and/or capture at 215, such as by the edge device capture router 240. The edge device capture router, at 304, may link with one or more edge devices via the edge device manager 210 to trigger capture, by a local video capture edge device 241, a video snippet of a portion of the transaction (e.g., a user portion of the transaction and/or an enterprise portion of the transaction at 242. The edge device capture router, at 304, may link with one or more edge devices via the edge device manager 210 to trigger capture, by a local audio capture edge device 244, an audio snippet of a portion of the transaction (e.g., a user portion of the transaction and/or an enterprise portion of the transaction at 245. The video snippet of a particular transaction captured by the edge device(s) may be stored in a video snippet database 243 at 305 and an audio snippet of the particular transaction captured by the edge device(s) may be stored in an audio snippet database 246 at 306. A validated audit database 247 may store information associated with the captured snippets and information corresponding to the associated transaction at 307, which may then be accessed by an evidence package serializer engine 248 to provide evidence of the completed transaction for audit purposes, as needed. The user device may further be enabled to notify the user at 250 of an addition to the enterprise network for use in facilitating the transaction verification process, such as via an application, where notification and/or completion of the transaction may be finalized at 252.

Returning to 252, the DB entry trigger for capture 215 may further cause entry of transaction information into a teller entry database 216 and a customer and/or transaction database 218, where load balancers 232, disaster mitigation and/or continuity enablement mechanisms 234 may be used to ensure re-allocation of data, databases, and/or hardware resources to ensure completion of the transaction as efficiently as possible at 236. At 224, the customer and transaction database may link to a privacy consent server 224 to facilitate intake of requests (e.g., on-premises or remote), where a remote position utility request assignment 222 may associate a virtual assistant and/or may allow work with recorded screens and/or images in lieu of text or complaint requests to overcome technical issues when initiating or otherwise performing the transaction.

Definitions: On Premise Request Scenario: Requests arising from an on-premise section for transaction request processing & teller service. Remote Requests Scenario: Requests arising from remote regions for traveling transaction request processing & teller service delivery. The inclusion of spatial device requests, increases improved customer engagement, reduction of spatial devices at bank's end. NOTE: Incoming requests are initially processed through virtual tellers and assists (like Erica) however, a secondary provision of engaging a teller remotely by pulling in edge devices including remote spatial requests, devices and services is claimed. Dedicated business teller assignment: Setting up request delivery in remote positions across regions (the DB Load balancer modulates the request traffic and ensure resources distribution). Edge Device Capture Router (EDCR) component: Edge device pull setup for bank side localized entry processing. User Device Notification/Confirmation: a step to ensure transaction completion as reflected in teller database. In Vehicle and Drive Thru Capture Confirmation: a step to ensure remote transaction completion as reflected in teller database. Local Video Capture Edge Device: Create ViSi Video Snippet capture device integration into the system. Local Voice Capture Edge Device: Create VoSi Voice Snippet capture device integration into the system. Evidence Package Serializer Program (Evi-P-S): Enabling User, bank and vehicle edge devices into transaction validation system though Evi-P-S. An evidence bundling and validation notification system for automated flags and closure. The Evi-P-S enables remote delivery (due to natural disasters or other business continuity needs) validations.

In an illustrative example, such on-premise and remote transactions and teller services delivery system is highly desired from financial services perspective, when looking at information such as the transaction and teller service-related deliveries that are classified based on drive-thru teller services, accepts appointments, open Sundays, video Conferencing, ATM service Available, Express financial center, Advanced Center with Video Chat, and the like. However, emphasize on the need for remote traveling transactions and remote teller services delivery arise when you note that there are about 74 ATM locations within North Carolina, where almost 46 are located in and around a single city, Charlotte. Where these locations only have about 8 business tellers, about 10 home loan Specialists, no advanced centers enabled with video chat, and only 2 with drive-through tellers. Therefore, for improving client experience and satisfaction and to engage all their service requests, a system must be able to operate on both on-premise and remote transaction initiate to enable the system to assign, process and validate both entry points the same is desired.

The system and methods dynamically allocate edge devices that are surrounding a particular data exchange transaction. In an illustrative example, special requests may come in from a variety of video mixed reality sources, such as for remote transactions and/or remote teller services delivery, along with those to be delivered locally. Such processes may be common to completing data exchange transactions across regions (e.g., cross city, cross border, cross state, cross country, and the like) and/or computing systems. One illustrative example for the data exchange transactions system includes integrating a process for teller service delivery and may include the digital service delivery. This combined process may automate future requests and a virtual assistant to address issues and facilitate completion of the data exchange process.

In an illustrative example, an enterprise organization may process approximately 30,000 electronic transactions and/or other data exchange transactions per day, where a large portion may require an extended processing time (e.g., 2-3 days) to complete. Such delays are not due to process inefficiencies, but may be due to other technical challenges such as database failures. Such database failures may occur during operations on a database during high volume access times. For example, entry lag and/or other latency issues may increase during high volume access times of database systems, particularly when entering large numbers of details into a particular row. Similar issues may occur with direct computing device assisted electronic transactions that may involve multiple computing devices and/or computing device types. As such a need has been recognized to provide a computing framework to leverage existing computing systems, devices, and/or applications within the enterprise computing network and/or user devices local and/or remote to the enterprise computing network, such as mobile phone, laptop computers, personal computers and the like.

In some cases, the dynamically allocated edge device system may facilitate data exchange requests (e.g., an electronic transaction) from (and/or to) one or more remote computing devices. For example, the dynamically allocated edge device system may facilitate completion of an electronic transaction in locations where an enterprise network device (e.g., an automated teller machine) is not locally available. In some cases, the dynamically allocated edge device system may process the electronic transaction and deliver completion at a second location, such as during a disaster recovery (e.g., network outage condition), and/or a enterprise network continuity issue and may further be applied to completing a request during travel conditions at a geographic condition where the enterprise network lacks networked computing devices and/or for foreign exchange requests. In such conditions, a user in a first device may initiate a request within a vicinity of the dynamically allocated edge device system to complete the request at a second geographic location remote from a location in which the electronic transaction was initiated.

The dynamically allocated edge device system may include one or more supporting frameworks and supporting technologies to mitigate issues due to any single point of failure, such as a database failure that may cause loss of information for an electronic transaction.

FIG. 2 shows an illustrative example of the dynamically allocated edge device system 200 and two illustrative entry points (e.g., an on-premises request scenario 301 and a remote request scenario 302) for initiating a data exchange transaction, such as an electronic transaction of value. With on-premises requests, a user may a setting, such as a financial institution, to perform an in-person exchange (e.g., a purchase, a banking transaction, and the like.) In the remote request scenario 302, a user may initiate a request at a first location with a completion at a different location, such as a “traveling request”, were the user's movements may require cross-border operations.

A challenge for current systems, separate workflow processes are used to address these scenarios, but transactions are processes similarly. The dynamically allocated edge device system utilizes present systems to process the transactions, but also addresses and mitigates the single points of failure and incorporates current and future edge device technologies. Currently, the single point of failure for multiple transaction types (e.g., on-premises transactions 201, remote transactions, such as the request intake 232, and the like) may occur during a transaction capture or initiation, where a teller completes the transaction, with a concurrent database entry capture. In such cases, the triggering of the database transaction is stored in the teller entry database and includes information corresponding to the teller, the customer, the completed transaction information, where the database entry may have at least a minimum of 30 or 35 (or more) columns (e.g., location, time, date, time and the like), where the same information is recorded in the transaction database to include final disposition information of the transaction (e.g., complete, failed, and the like).

In such conditions, such as where both on-premises and remote requests for data exchange transactions in addition to other data access requests to and from the database systems, the enterprise system may face the single point of failure scenario. Such problems may occur due to additional processing being performed by the existing process and systems, where the database systems must confirm all transaction interactions where transactions from both the on-premises request scenario 301 and the remote request scenario 302 are to be confirmed where all the thirty or more columns after processing should be entered within a matter of seconds, not to mention other data access conflicts as well. For example, an on-premises request may appear to be completed within the enterprise computing network, but still may show to be pending on the customer side (e.g., within an application on the user's device). For example, the user device may still be awaiting generation or completion of one or more security measures (e.g., generation of one-time passwords, generation and/or receipt of a short messaging services (SMSS) message, and/or the like) or awaiting resolution of a point of failure condition within the enterprise network that is overcome by the dynamically allocated edge device system 200. The dynamically allocated edge device system 200 dynamically identifies and/or includes edge devices available at one or more different points within the process, such as user-side devices and/or enterprise edge devices (e.g., a user edge device 212, an enterprise edge device 214, such as a smart phone, a smart watch, an augmented reality (AR) and/or virtual reality (VR) headset, a security camera, an audio capture device, and the like). The edge device manager 210 may be a computing device configured to identify and/or otherwise facilitate connection of identified edge devices to the dynamically allocated edge device system 200. The edge device manager 210 may identify locally enabled options such as mobile phones, laptops computers, our AR/VR headset, head sets, and also extending facilitating connections to other environmental smart devices, such as one or more edge device components integrated into modern vehicle systems and/or available via a vehicle system. The dynamically allocated edge device system 200 may facilitate use of identified and connected edge devices associated with the user and/or the enterprise network corresponding to different data exchange transactions, such as a digital exchange of value between different computing systems) more efficiently process and/or enhance processing times by utilizing edge device processing capabilities for a seamless and quick connection such that database accesses and/or communications are seamless.

In some cases, the edge device manager 210 may comprise one or more edge device capture routers. A WIFI router may send and/or receive signals via an interim service provider to all of the edge devices are local to the Wi Fi router. The edge device manager 210, operating as an edge device capture router, may provide router capabilities to dynamically identify and connect locally available devices associated with each particular data exchange transaction, to associate and connect the corresponding edge devices to an enterprise organization specific router for that particular data exchange transaction. As such, the edge device manager 210 securely associates edge devices for the application to avoid possible data lags or latency issues with external communication events and/or to minimize exposure to possible security flaws that may be exposed due to communications to a larger outside or public network.

All local edge devices associated with a particular data exchange event may be captured and managed by the edge device manager 210 for local processing of the data exchange transaction. This local processing instance may be common to both the on-premises scenario 301 and the remote request scenario 302 to streamline the process to provide a common secure method to validate each transaction quickly and locally to associated edge devices to avoid unintended exposure to security flaw and to avoid data lag issues due to, for example, a single point of failure issues with centralized database access events. For example, a user-end edge device may receive confirmation that the data exchange transaction is being processed and/or completed in real-time (e.g., real-time confirmation that the system processing has started, the enterprise system is fetching the details and content of the data exchange transaction) where the information is delivered within in seconds. For an on-premises request scenario 301, the user receive confirmation 250 at the user edge device and the user gets the details of the data exchange transaction (e.g., confirmation of a deposit, confirmation of movement of data from one data storage area to a second data storage area, delivery of a physical confirmation of the transaction, and/or the like) within a very short timeframe. In doing so, the dynamically allocated edge device system 200 creates a seamless experience for all users participating in the data exchange transaction by connecting a few of the devices together to avoid issues caused by a single point of failure where the DB capture fails such that confirmation fails to be timely reflected on the customer side and/or at the enterprise organization side of the exchange.

The enterprise network may include a supporting framework of edge devices that may be utilized by the dynamically allocated edge device system 200. For example, the enterprise network may utilize a closed circuit television (CCTV) camera that may be previously installed for security purposes. Further, the camera and/or headsets or other components (e.g., a digital assistant enabled computing device) may further include a microphone capable of capturing audio signals within the vicinity of a transaction initiation event. For example, at a bank drive-through window or within a bank at a customer service kiosk, a computing device may include a microphone to facilitate communications to and from a user. As such, the dynamically allocated edge device system 200 includes video and/or audio capture capabilities, and may capture an audio snippet and/or video snippet of activities during the transaction. In an illustrative transaction, an audio snippet may include something such as an audio confirmation of a request, a confirmation that the request was heard, and a snippet confirming that both parties to the exchange confirm the substance of the exchange (e.g., a request for a particular object or financial amount).

The dynamically allocated edge device system 200 may add each captured audio or video snippet to corresponding snippet databases (e.g., a voice snippet (VSI) database 243, a video snippet database (246), as a hedge of the single point of failure. As such, the dynamically allocated edge device system 200 provides real-time evidence capture to support the traditional data exchange confirmation processes of a database capture from a tele-database entry and/or a customer database entry.

Because the single points of failure is now being supported by the edge device capture router (EDCR) 240, the EDCR 240 of the enterprise network may now confirm that a particular data exchange transaction was initiated by a particular user associated with a user edge device 212 and was acknowledged by the enterprise network associated with the enterprise edge device 214 that automatically captures information (e.g., audio snippet(s), video snippet(s)) confirming that the data exchange transaction was initiated and/or completed. As such, the dynamically allocated edge device system 200 provides a supporting framework of video snippets and voice snippets that confirm transactions, the people involved, the details of the transaction, and the closure of the transaction. Such confirmations do not already exist in real time due to single point of failure issues with database systems underlying the data exchanges, where current security measures, such as one-time passwords, may not timely be communicated and received by the customer on time. In some cases, the completion of a transaction may be delayed due to a referral management system where each of the transaction may be validated after the completion (e.g., three months, four months, six months, and the like) where system samples data from different transactions and validates whether the process was successful and/or the data correctly transferred.

The referral management system fails to validate all transactions, rather it validates only a small number sample cases. However, the dynamically allocated edge device system 200 stores and provides easily verifiable evidence for each exchange, where the evidence is available for all transactions, via an evidence package serializer engine 248 and/or a validated audit database 247. The dynamically allocated edge device system 200 allows for easily performed checks to the customer was there, whether the voice supports the transaction and you have a package serialized and bundled and ready to be automatically processed that the transaction is valid, such that the dynamically allocated edge device system 200 may provide validated evidence of no failures or fraud. The packaged audio and/or video snippets provide proof that a request was initiated by the customer, along with confirmed components from the enterprise-side of the transaction. In short, the dynamically allocated edge device system 200 provides supplemental and real-time confirmation of data exchange transactions via dynamically allocated edge devices associated with participants of the transaction in parallel to existing systems to eliminate delays due to failures cause by the database single point of failure. The dynamically allocated edge device system 200 also may eliminate the single point of failure by supplementing information in the existing data by associated the evidence package (e.g., via a link or pointer to the validated video/audio snippet package to validate each entry in the database.

The remote request scenario 302 includes a number of heuristic components and/or computing devices including smart vehicle components which may comprise audio and/or video components. Further, mobile devices may include geolocation technologies that may not exist in many building components and/or built-in computing devices. The remote request scenario 302 begins with a request, such as via the remote request intake 232, such as via a first location 234 in a first city using a first computing device (e.g., an automated teller machine). Currently, such a remote transaction may take a long time to complete, such as even days or weeks if it is a foreign exchange request or a traveling request. In some cases, certain transaction and/or device conditions may require the user to visit the enterprise organization (e.g., a banking premises) to resolve any issues.

While many enterprise organizations have multiple locations in a city, county, state, and/or region to allow a user flexibility on places to initiate and/or complete a transaction. However, in many cases, the enterprise organization may not have location that offers all desired services, if present at all. In an illustrative example, a user may initiate a transaction in a first city, but cannot wait for the completion (e.g., day or week delay). For example, the user may need the transaction to be delivered at a second location in another state or region, including cross-border or in multiple countries. In the remote request scenario 302, the user may utilize a vehicle that is capable of processing the request in a three-dimensional manner or in a mixed reality kind of way. For example, the user may wear an AR/VR enabled headset, goggles, or glasses that while initiating the transaction, such as with a drive-through teller or at an ATM. In some cases, the user may notice issues with the display or the buttons are not working on the ATM, or other user interface issues (e.g., a missing submit button). As such, the user may show the request directly to an assigned specialist teller. The dynamically allocated edge device system 200 utilize extended reality capabilities, along with audio and/or video capture capabilities to complete and verify the transaction with no further delays.

The dynamically allocated edge device system 200 stores details in the customer database provides capabilities to utilize audio/video feeds captured via user edge devices and/or enterprise edge devices. The dynamically allocated edge device system 200 may record user interactions with individuals and/or computing devices, such as to record a record having screen inputs and images and a transcript describing the user's conversation and/or request such that an A/V clip is not needed to view, but has an additional record of the actual content of the A/V clip providing a statement or a record of steps that the user needs. Here, the enterprise computing system can act without compromising user privacy. The dynamically allocated edge device system 200 may assist the user's vehicle and/or via mobile devices to travel to a location to a location to complete the transaction, when not automatically resolved.

The dynamically allocated edge device system 200 may initiate steps 302-304 via the remote service request. As such, the user spends minimal time at ATM 1, the steps have been recorded, the request is logged, and the user travels to another location (e.g., across the city, cross country travel and/or the like. The user may travel without worry about delay lag or whether the transaction will complete at the destination. As such, step 304b operates similarly to 304a, including an option to connect with a user edge device and/or an enterprise edge device.

To show notifications bypassing the one-time passwords, the SMS lag, and/or the like, the vehicle or other user associated edge device may utilize an in-vehicle capture of the user initiating a transaction such as using the voice and/or video snippet assist support. As such, a remote request involving foreign exchange activities, foreign exchange tellers, and/or any traveling request is being addressed by the dynamically allocated edge device system 200 in the same way as an on premises request via the framework with no additional architecture required. In some case, the dynamically allocated edge device system 200 may leverage the user side of the details provided we have the privacy consent.

The dynamically allocated edge device system 200 may treat all requests equally in all the places. As such, the dynamically allocated edge device system 200 may assign a specialist teller to the anywhere in the country, state, or even cross borders. In some cases, such as when a group of people may travel to attend an event, concert, or meeting. Any requests may be load balanced between different database machines to avoid that single point of failure. The database load balancers may redirect certain requests to certain tellers or certain databases. The operation of which may be a replica of a disaster mitigation or a disaster recovery plan, business continuity plan, and the like. In essence, the load balancers may identify whether operations in particular locations are available and/or inaccessible, such that the load balancers may route requests to different cities and/or devices. In doing so, the dynamically allocated edge device system 200 allows for same services and/or same capabilities available to the user and may route problematic requests to a nearest location and/or available device so that no delay lag exists for the customer due to processing delays and/or re-entry of security measures for validation of the customer with the enterprise computing network. One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a user computing device comprising a video capture device and an audio capture device;
a computing platform, comprising:
a processor; and
memory storing computer-readable instructions that, when executed by the processor, cause the computing platform to:
receive a request to initiate an electronic data exchange transaction;
identify one or more edge devices adjacent to a location of a user of the user computing device, wherein the user computing device comprises a first edge device of the one or more edge devices;
capture, by an identified edge device of the one or more edge devices and during the initiation of the electronic data exchange transaction, one or both of a video snippet and an audio snippet; and
verify, based on one or both of the video snippet and the audio snippet, completion of the electronic data exchange.

2. The system of claim 1, wherein the instructions cause the computing platform to receive the request to initiate the electronic data exchange transaction comprises receiving information via an enterprise computing device.

3. The system of claim 1, wherein the instructions cause the computing platform to receive the request to initiate the electronic data exchange transaction comprises receiving information via one or more edge computing devices.

4. The system of claim 1, wherein the data exchange transaction comprises a request to transfer value from a first computing system to a second computing system.

5. The system of claim 1, wherein the data exchange transaction is initiated at a first geographic location and completed at a second geographic location.

6. The system of claim 1, wherein the one or more edge devices comprises a user edge device and an enterprise computing system edge device.

7. The system of claim 6, wherein the enterprise computing system edge device comprises a closed-circuit television camera.

8. The system of claim 1, wherein the electronic data exchange transaction is initiated and completed at a first geographic location.

9. The system of claim 1, wherein the electronic data exchange transaction is initiated at a second geographic location and completed at a third geographic location.

10. The system of claim 1, wherein the one or more edge devices comprise one or more of a smart phone, a laptop, a smart watch, and an augmented reality computing device associated with a user.

11. The system of claim 1, wherein the one or more edge devices comprise one or more of a smart phone, a laptop, a smart watch, a closed-circuit television camera, and an augmented reality computing device associated with an enterprise computing network.

12. Non-transitory computer readable media storing instructions that, when executed by a processor, cause a computing platform to:
receive a request to initiate an electronic data exchange transaction;
identify one or more edge devices adjacent to a location of a user of a user computing device, wherein the user computing device comprises a first edge device of the one or more edge devices;
capture, by an identified edge device of the one or more edge devices and during the initiation of the electronic data exchange transaction, one or both of a video snippet and an audio snippet;
verify, based on one or both of the video snippet and the audio snippet, completion of the electronic data exchange; and
validate, based on the verified completion of the electronic data exchange, entry of a database entry corresponding to the completed electronic data exchange.

13. The non-transitory computer readable media of claim 12, wherein the instructions cause the computing platform to receive the request to initiate the electronic data exchange transaction comprises receiving information via an enterprise computing device.

14. The non-transitory computer readable media of claim 12, wherein the instructions cause the computing platform to receive the request to initiate the electronic data exchange transaction comprises receiving information via one or more edge computing devices.

15. The non-transitory computer readable media of claim 12, wherein the data exchange transaction comprises a request to transfer value from a first computing system to a second computing system.

16. The non-transitory computer readable media of claim 12, wherein the data exchange transaction is initiated at a first geographic location and completed at a second geographic location.

17. The non-transitory computer readable media of claim 12, wherein the one or more edge devices comprises a user edge device and an enterprise computing system edge device.

18. The non-transitory computer readable media of claim 17, wherein the enterprise computing system edge device comprises a closed-circuit television camera.

19. The non-transitory computer readable media of claim 12, wherein the electronic data exchange transaction is initiated and completed at a first geographic location.

20. The non-transitory computer readable media of claim 12, wherein the electronic data exchange transaction is initiated at a second geographic location and completed at a third geographic location.
